(19) United States
(12) Patent Application Publication
(10) Pub. No.: US 2017/0118655 A1
(43) Pub. Date: Apr. 27, 2017

(54) METHOD AND DEVICE FOR SAME BAND CO-LOCATED RADIOS

(71) Applicant: Cisco Technology, Inc., San Jose, CA (US)

(72) Inventors: John Martin Blosco, Norton, OH (US); Stephen Joseph McCarthy, Norton, OH (US); Matthew Aaron Silverman, Shaker Heights, OH (US); Erin Patrick McGough, Akron, OH (US)

(21) Appl. No.: 15/043,336

(22) Filed: Feb. 12, 2016

Related U.S. Application Data
(60) Provisional application No. 62/245,911, filed on Oct. 23, 2015.

(51) Int. Cl. H04W 16/28; H01Q 21/28

(52) U.S. Cl. CPC H04W 16/28; H01Q 21/28

(57) ABSTRACT

In one implementation, a device includes a first set of antennas having a first polarization; and a first radio coupled to the first set of antennas, the combination of the first set of antennas and the first radio supporting a first signal. The device also includes: a second set of antennas having a second polarization, the second polarization is different from the first polarization; and a second radio coupled to the second set of antennas, the combination of the second set of one or more antennas and the second radio supporting a second signal, the second signal is independent of the first signal. In some implementations, the first radio is operated according to a first power level in order to establish the first coverage area, and the second radio is operated according to a second power level in order to establish the second coverage area.

### RELATED APPLICATION(S)

This application claims the benefit of U.S. Provisional Patent Application No. 62/245,911, filed on Oct. 23, 2015, the disclosure of which is hereby expressly incorporated by reference in its entirety.

### TECHNICAL FIELD

The present disclosure generally relates to wireless networking devices, and in particular, to wireless networking devices with at least two same-band co-located radios.

### BACKGROUND

Current wireless access points (APs) allow for simultaneous operation in different bands (e.g., one in the 2 GHz band and one in the 5 GHz band). However, previously available APs experience highly degraded performance when two co-located radios operate within the same band (e.g., two radios operating in the 5 GHz band). The reason for this is that when one radio is transmitting in close proximity to another radio that is receiving, packet reception is degraded by interference, and throughput scaling is not achieved. Two factors that cause the interference include receiver overdrive, and excessive transmitter noise floor.

Radio hardware is designed to operate over a wide frequency range in a particular band (e.g., channels in the 5 GHz band). As such, receivers have gain and signal detection circuitry over the entire band. If one co-located and same-band radio transmits a high level signal, the high level signal can overdrive the other radio when it is receiving a desired signal due to close physical and spectral proximity of the radios. When this blocking occurs the radio that is receiving will typically lose any packets that it is currently decoding. This results in a loss of potential throughput and a “sharing” of the air time between the radios.

The second issue that limits the same band operation of co-located radios is excessive transmitter noise floor that exists in integrated circuits manufactured using currently available silicon processing technology. Currently available integrated circuits and associated hardware have limited out of band noise transmission using limited filtering capabilities which reduce baseband noise. This “transmitter noise floor” is apparent across the entire band of operation. This noise will appear in the band of the co-located same-band radio and limit the signal-to-noise-plus-interference-ratio (SINR) of that radio and in turn limit the range of that radio. If this noise shows up during a packet reception it impacts the received signal's SINR greater than what that packet modulation can accept. As a result, in some circumstances, the received packet will be lost.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1D show block diagrams of example operating scenarios in accordance with some implementations.

FIG. 2 is a block diagram of an example antenna arrangement in accordance with some implementations.

FIG. 3 illustrates the polarization of a first antenna of the antenna arrangement in FIG. 2 in accordance with some implementations.

FIG. 4 illustrates the polarization of a second antenna of the antenna arrangement in FIG. 2 in accordance with some implementations.

FIG. 5 is a block diagram of another example antenna arrangement in accordance with some implementations.

FIG. 6 illustrates the polarization of a third antenna of the antenna arrangement in FIG. 5 in accordance with some implementations.

FIG. 7 illustrates an example operating environment of a dual radio access point (AP) in accordance with some implementations.

FIG. 8A is an example graphical representation of the range versus throughput for a first radio of the dual radio AP in FIG. 7 in accordance with some implementations.

FIG. 8B is an example graphical representation of the range versus throughput for a second radio of the dual radio AP in FIG. 7 in accordance with some implementations.

FIG. 8C is an example graphical representation of the total range versus throughput for the dual radio AP in FIG. 7 in accordance with some implementations.

FIGS. 9A-9D show example performance diagrams of the two radios of the dual radio AP in FIG. 7 for various operating scenarios in accordance with some implementations.

FIGS. 10A-10D show example performance diagrams of combined data associated with FIGS. 9A-9D for various operating scenarios in accordance with some implementations.

FIGS. 11A-11D show example performance diagrams of a first radio of the dual radio AP in FIG. 7 operating in a macro mode for various operating scenarios in accordance with some implementations.

FIGS. 12A-12D show example performance diagrams of a second radio of the dual radio AP in FIG. 7 operating in a micro mode for various operating scenarios in accordance with some implementations.

FIG. 13A illustrates an example far-field radiation pattern as taken from the antenna elevation plane of the first radio of the dual radio AP in FIG. 7 operating in a macro mode in accordance with some implementations.

FIG. 13B illustrates an example far-field radiation pattern as taken from the antenna elevation plane of the second radio of the dual radio AP in FIG. 7 operating in a micro mode in accordance with some implementations.

FIG. 14 illustrates a schematic diagram of an example device in accordance with some implementations.

FIG. 15 is a block diagram of an example device in accordance with some implementations.

FIG. 16 is a flowchart representation of a method of operating a dual radio AP in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION OF EXAMPLE EMBODIMENTS

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

### Overview

Various implementations disclosed herein include devices, systems, and methods for enabling same-band co-located radios. For example, in some implementations, a device includes: a first set of one or more antennas having a first polarization; a first radio coupled to the first set of one or more antennas, the combination of the first set of one or more antennas and the first radio supporting a first signal; a second set of one or more antennas having a second polarization, where the second polarization is different from the first polarization; and a second radio coupled to the second set of one or more antennas, the combination of the second set of one or more antennas and the second radio supporting a second signal, where the second signal is independent of the first signal. In some implementations, the device also includes an antenna control module configured to operate the first radio in order to establish a first coverage area and to operate the second radio in order to establish a second coverage area. In some implementations, the first radio is a transmitter and the second radio is a receiver. In some implementations, the first radio is operated according to a first power level in order to establish the first coverage area, and the second radio is operated according to a second power level in order to establish the second coverage area. In some implementations, the second power level is set relative to the first power level to satisfy an isolation criterion.

In some implementations, for example, a device includes: a plurality of antennas each having a respective polarization, where the respective polarizations of each antenna are set in order to satisfy an isolation criterion relative to one or more adjacent antennas within the plurality of antennas; a first radio coupled to a first antenna of the plurality of antennas, the combination of the first antenna and the first radio supporting a first signal; and a second radio coupled to a second antenna of the plurality of antennas, the combination of the second antenna and the second radio supporting a second signal, where the second signal is independent of the first signal. In some implementations, the device also includes an antenna control module, comprising one or more controllers and a non-transitory memory storing one or more programs, which when executed by the one or more controllers cause the device to operate the first radio in order to establish a first coverage area and to operate the second radio in order to establish a second coverage area. In some implementations, the device also includes an antenna control module including logic configured to operate the first radio in order to establish a first coverage area and to operate the second radio in order to establish a second coverage area.

In some implementations, for example, a system includes: a plurality of antennas each having a respective polarization, where the respective polarizations of each antenna are set in order to satisfy an isolation criterion relative to one or more adjacent antennas within the plurality of antennas; a first radio coupled to a first antenna of the plurality of antennas, the combination of the first antenna and the first radio supporting a first signal; and a second radio coupled to a second antenna of the plurality of antennas, the combination of the second antenna and the second radio supporting a second signal, where the second signal is independent of the first signal. The system also includes: one or more processors; and a non-transitory memory storing one or more programs, which when executed by the one or more controllers cause the device to operate the first radio in order to establish a first coverage area and to operate the second radio in order to establish a second coverage area.

In accordance with some implementations, a method includes steps for performing or causing performance of any of the operations of the devices or systems described herein. In accordance with some implementations, a non-transitory computer readable storage medium has stored therein instructions, which, when executed by one or more processors of a device, cause the device to perform or cause performance of any of the operations of the devices or systems described herein. In accordance with some implementations, a device includes: one or more processors, a non-transitory memory, and means for performing or causing performance of the operations of the devices or systems described herein.

### Example Embodiments

As discussed above, previously available access points (APs) experience highly degraded performance when two co-located radios operate within the same band (e.g., two radios operating in the 5 GHz band). Receiver blocking and the transmitter noise floor are issues that result due to the radios not having enough isolation between them and the limitations of currently available integrated circuit silicon design. Some devices on the market attempt to solve these problems by using filtering on both the transmission and reception paths of the radio. This has some benefits, but it physically locks the radio into specific channels and does not allow the radios to operate across the entire allowed channel range of a given band. The filtering is also expensive, bulky and adds undesirable in-band loss to the design, which, in turn, affects other parameters. Other attempts to solve these problems have made use of directional antennas. This is difficult to do with smaller wireless local area network (WLAN) APs at traditional power levels. This potential solution also has issues when operating in conditions with multiple-input and multiple-output (MIMO), where it is desirable for signals transmitted from all antennas to have a particular receiver.

This disclosure provides various implementations of co-located, same-band radios that use antenna polarization diversity between antennas. Additionally and/or alternatively, in various implementations, relative coverage area sizing is used to facilitate the operation of co-located, same-band radios. This creates concentric coverage areas for clients in a “micro/macro” configuration that enables both radios to operate in a reduced interference manner.

In accordance with various implementations, antennas are provided with strong horizontal polarization (H-Pol) and vertical polarization (V-Pol) diversity. An isolated antenna with H-Pol will have low isolation when operating with another H-Pol antenna for a given gain/distance. If one of those antennas is replaced with an orthogonal polarity, such as V-Pol, higher isolation will be realized between the antennas. In indoor scenarios (e.g., not open space), electromagnetic (EM) waves are reflected off many objects and antenna polarization becomes mixed and less isolation is realized. However, if antennas are statically located, such as on a wireless access point (AP), this polarization isolation can remain relatively constant between antennas and higher isolation can be maintained.

In some implementations, a first set of one or more antennas associated with a first radio is characterized by a first polarization (e.g., strong vertical polarization) and a second set of one or more antennas associated with a second radio is characterized by a second polarization (e.g., strong horizontal polarization) to provide improved antenna isolation between radios operating in a same band. In some implementations, the second polarization is set relative to the first polarization to satisfy an isolation criterion (e.g., at least 30 dB, 40 dB, etc. of isolation). For example, the first polarization is orthogonal to the second polarization. In some implementations, the first polarization is not purely orthogonal to the second polarization. In fact, any polarization diversity provides improved antenna isolation between radios operating in a same band. In some implementations, the first and second polarizations satisfy an angular threshold relative to one another (e.g., at least a 70°, 75°, 80°, etc. offset). In some implementations, the angular threshold is indicative of an amount of polarization diversity that satisfies an isolation criterion.

In some implementations, the first set of antennas are characterized by a first directionality, and the second set of antennas are characterized by a second directionality. In some implementations, the directionality of the second set of antennas is set relative to the directionality of the first set of antennas to satisfy an isolation criterion (e.g., at least 30 dB, 40 dB, etc. of isolation). As a result, diversity of the directionality of the radios further improves antenna isolation between radios operating in a same band.

In some implementations, a first set of one or more antennas associated with a first radio is characterized by a first polarization (e.g., 0°), a second set of one or more antennas associated with a second radio is characterized by a second polarization (e.g., 90°), and a third set of one or more antennas associated with a third radio is characterized by a third polarization (e.g., 45°) to provide improved antenna isolation between radios.

Additionally and/or alternatively, using relative coverage area sizing for one of the radios can also be implemented to provide further isolation. For example, reducing the coverage area size of one of the co-located same-band radios relative to the other coverage area size results in one of the radios having lower transmitter power (e.g., lower interference relative to the other radio). In another example, increasing the coverage area size of one of the co-located same-band radios relative to the other coverage area size results in one of the radios having lower transmitter power (e.g., lower interference relative to the other radio).

In accordance with some implementations, different relative coverage area sizing of the co-located same-band radios also results in one of the radios being less susceptible to the artificial noise floor generated from the other radio. This approach creates two concentric circles of coverage around an AP and can be thought of as “micro” and “macro” coverage areas that can both serve clients in an un-interfered manner. Clients closer to the AP (with a better signal-to-noise-plus-interference-ratio (SINR)) can be directed to link to the micro coverage area, where clients further away from the AP can be directed to link to the macro coverage area.

In some implementations, an antenna control module configured to operate a first radio associated with a first set of one or more antennas in order to establish a first coverage area (e.g., a macro cell) and to operate a second radio associated with a second set of one or more antennas in order to establish a second coverage area (e.g., a micro cell). In some implementations, the first radio is operated according to a first power level in order to establish the first coverage area, and the second radio is operated according to a second power level in order to establish the second coverage area. For example, the first power level is greater than the second power level. In some implementations, the second power level is set relative to the first power level to satisfy an isolation criterion (e.g., at least 30 dB, 40 dB, etc. of isolation).

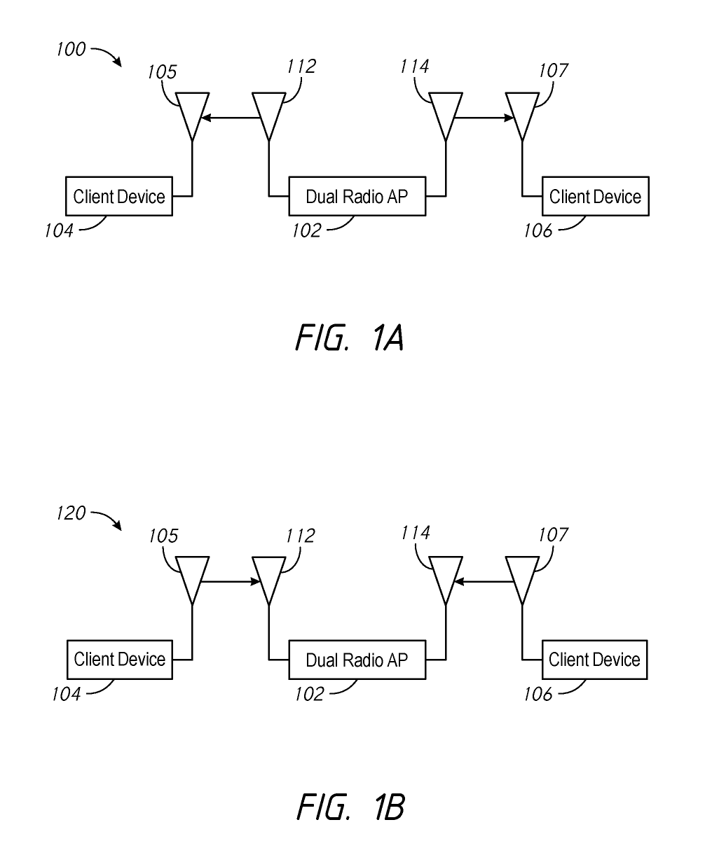

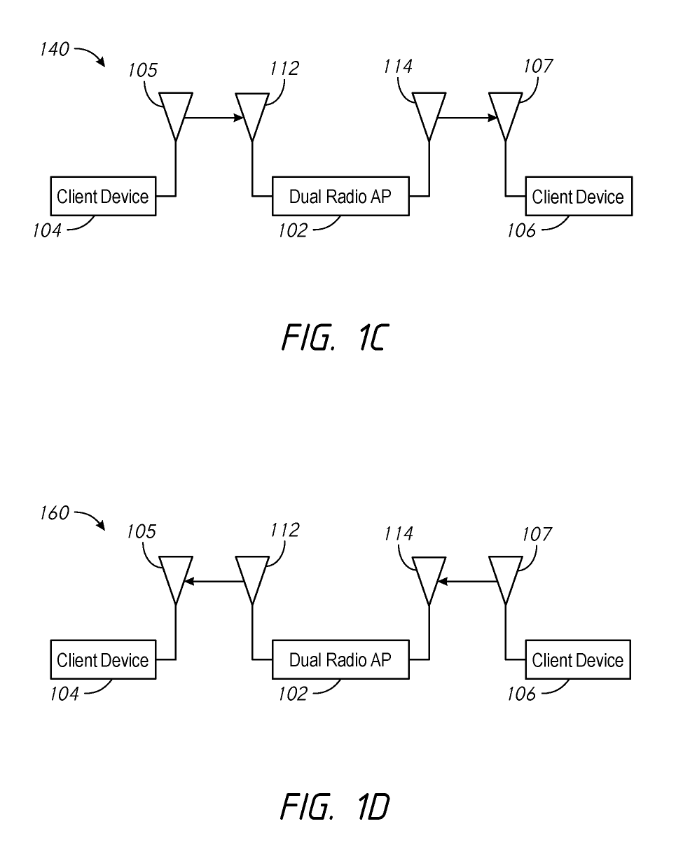

FIGS. 1A-1D show block diagrams of example operating scenarios in accordance with some implementations. In accordance with some implementations, a dual radio access point (AP) 102 includes a first radio coupled to a first antenna 112, the combination of which is configured to support a first signal. According to some implementations, the dual radio AP 102 also includes a second radio coupled to a second antenna 114, the combination of which is configured to support a second signal independent of the first signal. In some implementations, the first radio includes a transmitter, and the second radio includes a receiver. In some implementations, the first radio includes a transmitter and a receiver, and the second radio includes a transmitter and a receiver. In some implementations, the first radio includes a transmitter and a receiver, and the second radio includes a transmitter or a receiver.

In some implementations, the first antenna 112 is one of a first set of one or more antennas coupled to the first radio of the dual radio AP 102. In some implementations, the second antenna 114 is one of a second set of one or more antennas coupled to the second radio of the dual radio AP 102. In some implementations, the first set of antennas includes the same type as the second set of antennas (e.g., dipole antenna, half-wave dipole antenna, monopole antenna, loop antenna, etc.). In some implementations, the first set of antennas includes a different type from the second set of antennas.

FIG. 1A shows example operating scenario 100 in which the dual radio AP 102 transmits an information bearing signal via antenna 112 to client device 104, which receives the information bearing signal via antenna 105. In FIG. 1A, the dual radio AP 102 also transmits an information bearing signal via antenna 114 to client device 106, which receives the information bearing signal via antenna 107. As such, in FIG. 1A, both radios of dual radio AP 102 are operating in a transmission mode in the example operating scenario 100.

FIG. 1B shows example operating scenario 120 in which the dual radio AP 102 receives an information bearing signal via antenna 112 from client device 104, which transmits the information bearing signal via antenna 105. In FIG. 1B, the dual radio AP 102 also transmits an information bearing signal via antenna 114 from client device 106, which transmits the information bearing signal via antenna 107. As such, in FIG. 1B, both radios of dual radio AP 102 are operating in a reception mode in the example operating scenario 120.

FIG. 1C shows example operating scenario 140 in which the dual radio AP 102 receives an information bearing signal via antenna 112 from client device 104, which transmits the information bearing signal via antenna 105. In FIG. 1C, the dual radio AP 102 also transmits an information bearing signal via antenna 114 to client device 106, which receives the information bearing signal via antenna 107. As such, in FIG. 1C, the first radio of the dual radio AP 102 associated with antenna 112 is operating in a reception mode and the second radio of the dual radio AP 102 associated with antenna 114 is operating in a transmission mode in the example operating scenario 140.

FIG. 1D shows example operating scenario 160 in which the dual radio AP 102 transmits an information bearing signal via antenna 112 to client device 104, which receives the information bearing signal via antenna 105. In FIG. 1D, the dual radio AP 102 also receives an information bearing signal via antenna 114 from client device 106, which transmits the information bearing signal via antenna 107. As such, in FIG. 1D, the first radio of the dual radio AP 102 associated with antenna 112 is operating in a transmission mode and the second radio of the dual radio AP 102 associated with antenna 114 is operating in a reception mode in the example operating scenario 160.

According to some implementations, when the both radios of the dual radio AP 102 transmit or receive simultaneously (e.g., operating scenario 100 in FIG. 1A and operating scenario 120 in FIG. 1B) with far enough frequency separation, the interference between the two radios is controllable. Furthermore, in accordance with some implementations, if either of the radios is not transmitting or receiving, there also should not be interference problems. However, if one of the radios of the dual radio AP 102 is transmitting and the other is receiving (e.g., operating scenario 140 in FIG. 1C and operating scenario 160 in FIG. 1D), the receiving radio is subject to being overdriven and/or having an increased noise floor, which can degrade the received signal significantly. Furthermore, if both of radios of the dual radio AP 102 are transmitting (e.g., operating scenario 160) the increased SINR at the client devices 104 and 106 causes the transmitted signal to be corrupted.

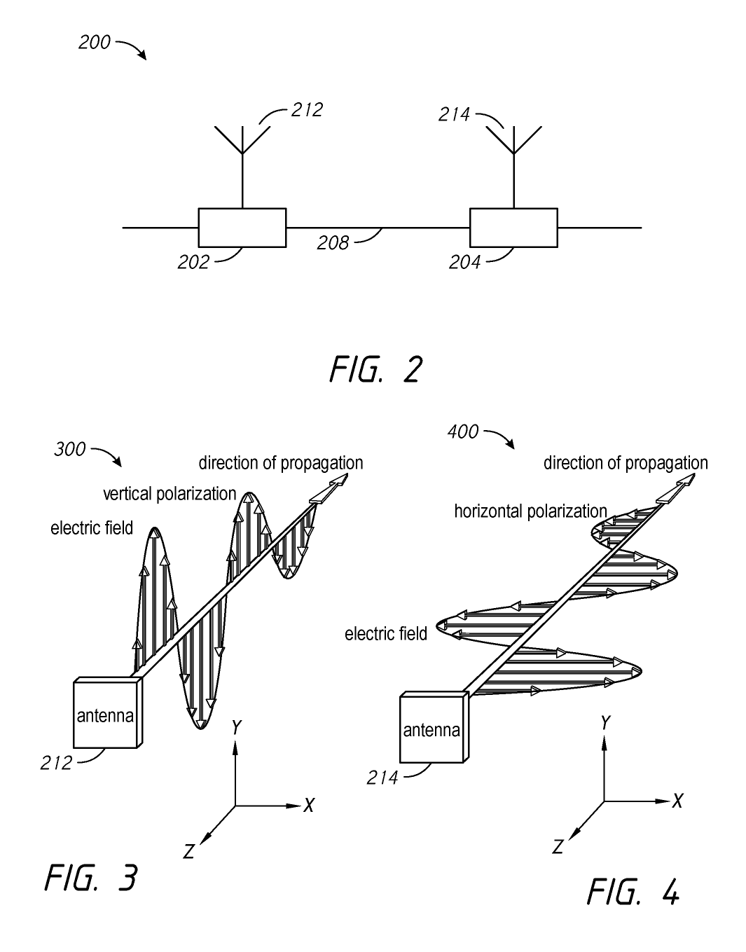

FIG. 2 is a block diagram of an example antenna arrangement 200 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the antenna arrangement 200 includes a first antenna mount 202 provided for a first antenna 212 and a second antenna mount 204 provided for a second antenna 214. According to some implementations, the first antenna mount 202 and the second antenna mount 204 are located on a substrate 208. In some implementations, the substrate 208 is a common ground plane.

For example, the first antenna mount 202 and the second antenna mount 204 are stamped concavities in the substrate 208. In another example, the first antenna mount 202 and the second antenna mount 204 are stamped convexities in the substrate 208. In yet another example, the first antenna mount 202 and the second antenna mount 204 are structures located on the substrate 208 for mounting and/or receiving the first antenna 212 and the second antenna 214, respectively.

FIG. 3 illustrates the polarization 300 of the first antenna 212 of the antenna arrangement 200 in FIG. 2 in accordance with some implementations. As shown in FIG. 3, the direction of propagation of signals transmitted by the first antenna 212 is along the Z axis. In some implementations, as shown in FIG. 3, the first antenna 212 is vertically polarized. In other words, in FIG. 3, the orientation of the electric field associated with signals transmitted by the first antenna 212 is along the Y axis (e.g., 90° relative to the X axis).

FIG. 4 illustrates the polarization 400 of the second antenna 214 of the antenna arrangement 200 in FIG. 2 in accordance with some implementations. As shown in FIG. 4, the direction of propagation of signals transmitted by the second antenna 214 is along the Z axis. In some implementations, as shown in FIG. 4, the second antenna 214 is horizontally polarized. In other words, in FIG. 4, the orientation of the electric field associated with signals transmitted by the second antenna 214 is along the X axis (e.g., 0° relative to the X axis). As such, in antenna arrangement 200 shown in FIG. 2, the first antenna 212 is vertically polarized, and the second antenna 214 is horizontally polarized.

In some implementations, the polarization 400 of the second antenna 214 is set relative to the polarization 300 of the first antenna 212 in order to satisfy an isolation criterion (e.g., at least 30 dB, 40 dB, etc. of isolation). For example, as shown in FIGS. 3-4, the polarization 300 of the first antenna 212 is orthogonal to the polarization 400 of the second antenna 214. In some implementations, the polarization 300 of the first antenna 212 is not purely orthogonal to the polarization 400 of the second antenna 214. In some implementations, the difference between the polarization 300 and the polarization 400 satisfies an angular threshold relative to one another (e.g., at least a 75° offset). In some implementations, the angular threshold is indicative of an amount of polarization diversity that satisfies an isolation criterion (e.g., at least 30 dB, 40 dB, etc. of isolation).

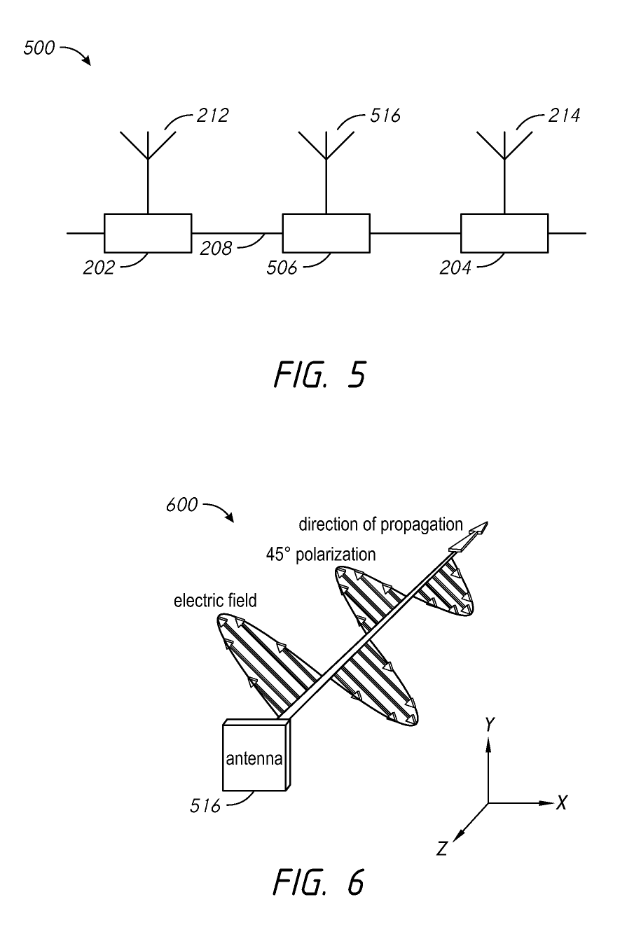

FIG. 5 is a block diagram of another example antenna arrangement 500 in accordance with some implementations. In FIG. 5, the elements of the antenna arrangement 500 are similar to and adapted from those discussed above with reference to the antenna arrangement 200 in FIG. 2. Elements common to FIGS. 2 and 5 include common reference numbers, and only the differences between FIGS. 2 and 5 are described herein for the sake of brevity. As shown in FIG. 5, the antenna arrangement 500 includes a third antenna mount 506 provided for a third antenna 516. According to some implementations, the first antenna mount 202, the second antenna mount 204, and the third antenna mount are located on a substrate 208. In some implementations, the substrate 208 is a common ground plane.

FIG. 6 illustrates the polarization 600 of the third antenna 516 of the antenna arrangement 500 in FIG. 5 in accordance with some implementations. As shown in FIG. 6, the direction of propagation of signals transmitted by the third antenna 516 is along the Z axis. In some implementations, as shown in FIG. 6, the third antenna 516 is polarized at a 45° angle. In other words, in FIG. 6, the orientation of the electric field associated with signals transmitted by the third antenna 516 is at a 45° angle (e.g., 45° relative to the X axis). As such, in antenna arrangement 500 shown in FIG. 5, the first antenna 212 is vertically polarized, the second antenna 214 is horizontally polarized, and the third antenna 516 is polarized at a 45° angle.

Those of ordinary skill in the art will appreciate from the present disclosure that the polarization 600 of the third antenna 516 are tuned to a different angle or phase relative to the polarization 300 of the first antenna 212 and the polarization 400 of the second antenna 214 according to various other implementations. For example, the difference between the polarization 300 and the polarization 600 satisfies a first angular threshold relative to one another (e.g., at least a 35° offset), and the difference between the polarization 400 and the polarization 600 satisfies a second angular threshold relative to one another (e.g., at least a 35° offset). In some implementations, the first and second angular thresholds are indicative of an amount of polarization diversity that satisfies an isolation criterion (e.g., at least 30 dB, 40 dB, etc. of isolation).

In accordance with some implementations, at least some polarization diversity provides improved antenna isolation between radios operating in a same band. As a result, the antenna arrangement 500 in FIG. 5 reduces the interference between three radios associated with antennas 212, 214, and 516 as compared to other APs with three radios. Those of ordinary skill in the art will appreciate that other implementations include three or more antennas or sets of antennas with varying polarization in order to improve antenna isolation among radios operating in a same band.

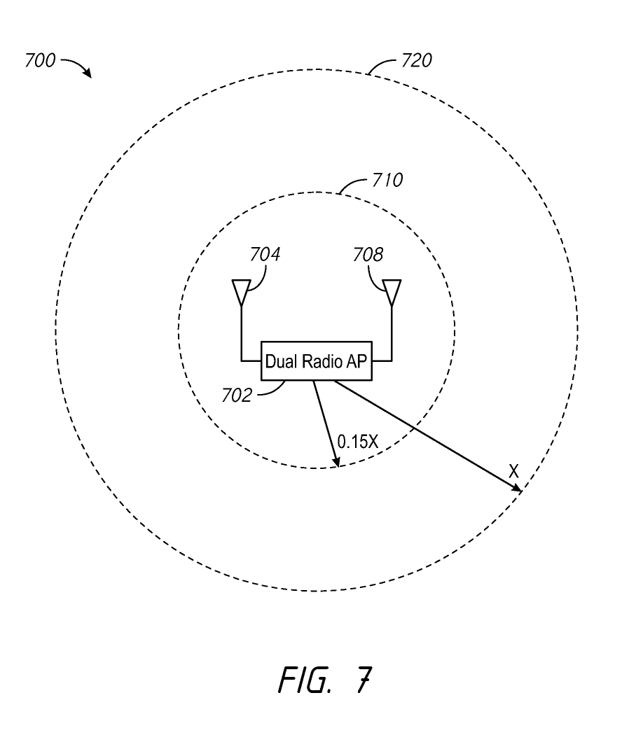

FIG. 7 illustrates an example operating environment 700 of a dual radio access point (AP) 702 in accordance with some implementations. As shown in FIG. 7, a first radio of the dual radio AP 702, which is coupled to antenna 704 (e.g., with vertical polarization), has a coverage area 720 with a radius X. As shown in FIG. 7, a second radio of the dual radio AP 702, which is coupled to antenna 708 (e.g., with horizontal polarization), has a coverage area 710 with a radius of, for example, 0.15 X. Those of ordinary skill in the art will appreciate that the size and shape of coverage areas 710 and 720 are different in other implementations. In some implementations, as shown in FIG. 7, the first coverage area 720 covers more area than the second coverage area 710.

In some implementations, an antenna control module of the dual radio AP 702 is configured to operate the first radio at a first power level (e.g., full power) in order to establish a first coverage area 720 (e.g., a macro cell) and to operate the second radio at a second power level (e.g., 15% power) in order to establish a second coverage area 710 (e.g., a micro cell). In some implementations, the first power level (e.g., 100% power) is greater than the second power level (e.g., 15% power). In some implementations, the second power level is set relative to the first power level to satisfy an isolation criterion (e.g., at least 30 dB, 40 dB, etc. of isolation).

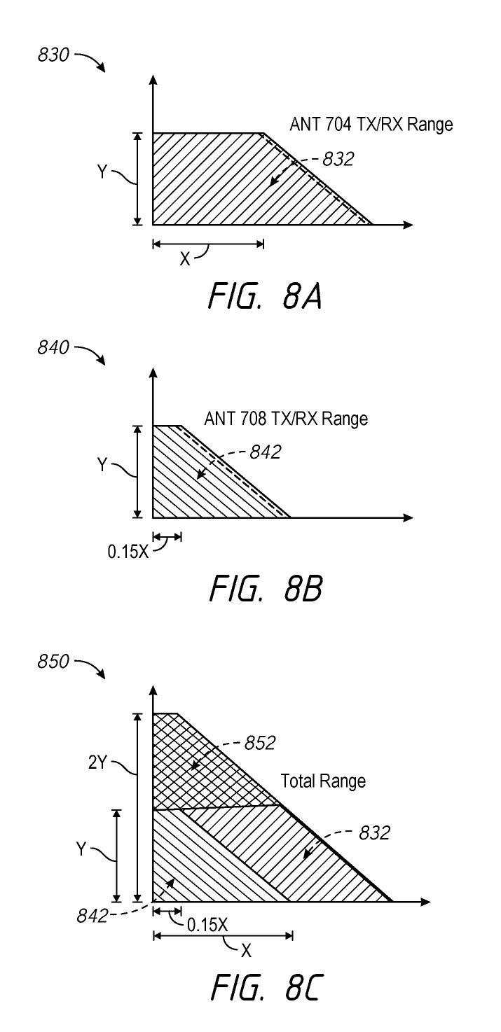

FIG. 8A is an example graphical representation 830 of the range versus throughput for a first radio of the dual radio AP 702 in FIG. 7 in accordance with some implementations. As shown in FIG. 8A, the Y axis of the graphical representation 830 indicates the throughput of the first radio of the dual radio AP 702, which is associated with antenna 704. Furthermore, the X axis of the graphical representation 830 indicates the range of the first radio of the dual radio AP 702, which is associated with antenna 704. In FIG. 8A, the area 832 indicates the performance of the throughput/range of the first radio of the dual radio AP 702, which is associated with antenna 704, when operating in a full power mode (e.g., a macro mode to produce the macro coverage area associated with coverage area 720 in FIG. 7).

FIG. 8B is an example graphical representation 840 of the range versus throughput for a second radio of the dual radio AP 702 in FIG. 7 in accordance with some implementations. As shown in FIG. 8B, the Y axis of the graphical representation 840 indicates the throughput of the second radio of the dual radio AP 702, which is associated with antenna 708. Furthermore, the X axis of the graphical representation 840 indicates the range of the second radio of the dual radio AP 702, which is associated with antenna 708. In FIG. 8B, the area 842 indicates the performance of the throughput/range of the second radio of the dual radio AP 702, which is associated with antenna 708, when operating in a reduced power mode (e.g., a micro mode to produce the micro cell associated with coverage area 710 in FIG. 7).

FIG. 8C is an example graphical representation 850 of the total range versus throughput for the dual radio AP 702 in FIG. 7 in accordance with some implementations. As shown in FIG. 8C, the Y axis of the graphical representation 850 indicates the total throughput of the dual radio AP 702. Furthermore, the X axis of the graphical representation 850 indicates the total range of the dual radio AP 702. In FIG. 8C, the area 852 indicates the added throughput/range of the dual radio AP 702 when the first radio associated with the antenna 704 is operating in the full power mode and the second radio associated with the antenna 708 is operating in the reduced power mode.

As such, when the power of one of the radios is reduced (e.g., the second radio associated with antenna 708), the amount of near-field impact to the other radio on its uplink is reduced. Moreover, this aligns the transmitter/receiver (TX/RX) range for both radios and creates a scenario with a high density radio and a (near) full range radio.

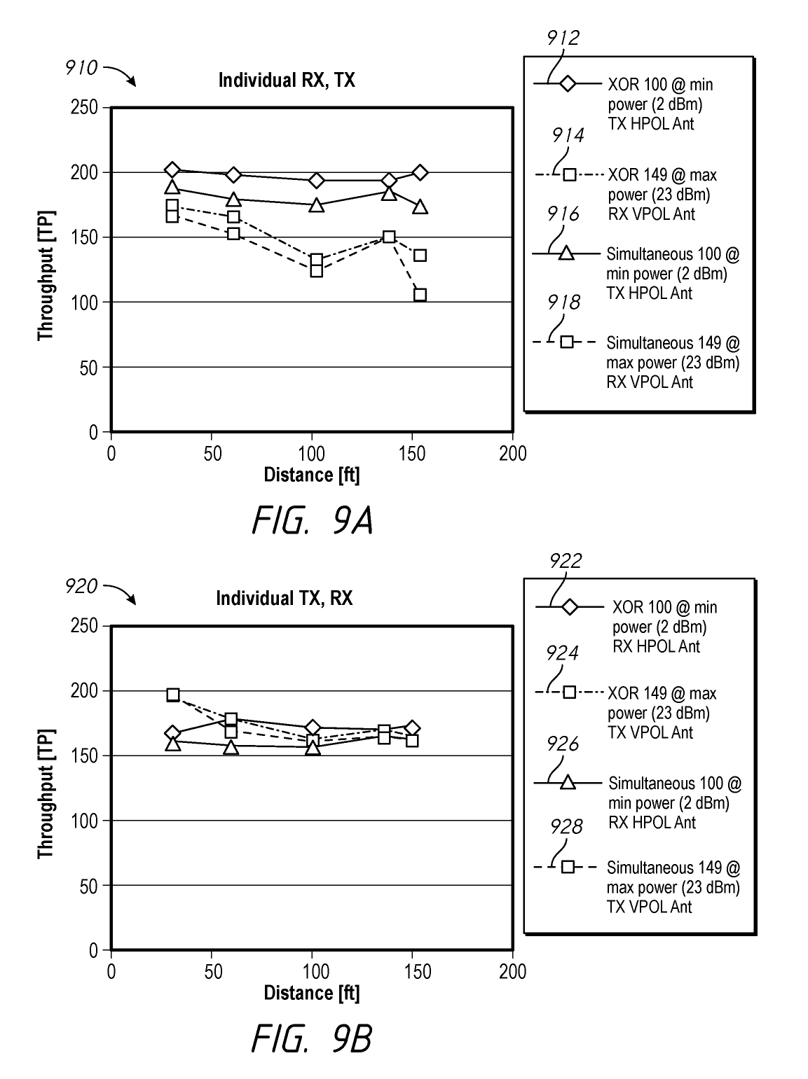

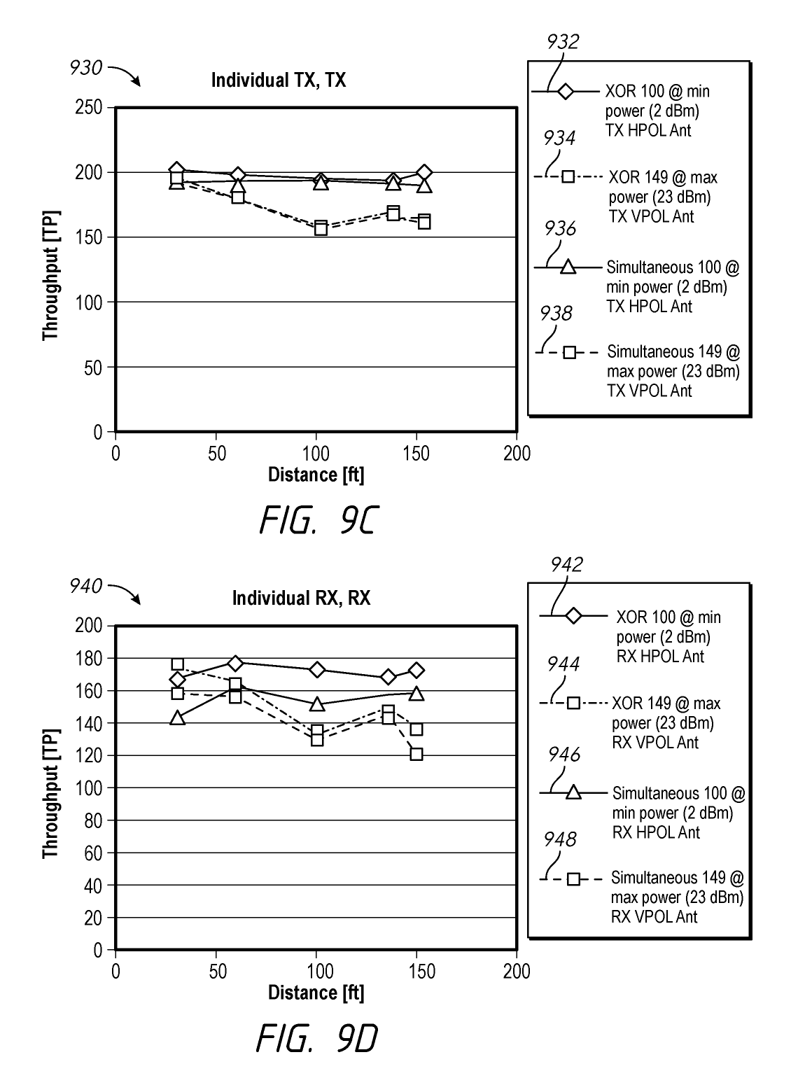

FIGS. 9A-9D show example performance diagrams of the two radios of the dual radio AP 702 in FIG. 7 for various operating scenarios in accordance with some implementations. The performance diagrams in FIGS. 9A-9D are non-limiting examples from the perspective of an access point (e.g., the AP 702 in FIG. 7). Those of ordinary skill in the art will appreciate from the present disclosure that the performance diagrams in FIGS. 9A-9D change according to the operating parameters and/or operating conditions in various other implementations. In FIG. 9A, the graphical representation 910 shows performance diagrams 912, 914, 916, and 918 with a vertically polarized antenna (e.g., antenna 704 in FIG. 7) associated with a first radio receiving (RX) a first signal while operating in a full power mode (e.g., 23 dBm) and a horizontally polarized antenna (e.g., antenna 708 in FIG. 7) associated with a second radio transmitting (TX) a second signal while operating in a low power mode (e.g., 2 dBm).

Performance diagram 912 shows range in feet versus throughput for the horizontally polarized antenna associated with the second radio transmitting the second signal while operating in the low power mode. With respect to performance diagram 912, only the second radio is operational. Performance diagram 914 shows range in feet versus throughput for the vertically polarized antenna associated with the first radio receiving the first signal while operating in the full power mode. With respect to performance diagram 914, only the first radio is operational.

Performance diagram 916 shows range in feet versus throughput for the horizontally polarized antenna associated with the second radio transmitting the second signal while operating in the low power mode. With respect to performance diagram 916, both of the radios are operational. Performance diagram 918 shows range in feet versus throughput for the vertically polarized antenna associated with the first radio receiving the first signal while operating in the full power mode. With respect to performance diagram 918, both of the radios are operational.

In FIG. 9B, the graphical representation 920 shows performance diagrams 922, 924, 926, and 928 with a vertically polarized antenna (e.g., antenna 704 in FIG. 7) associated with a first radio transmitting (TX) a first signal while operating in a full power mode (e.g., 23 dBm) and a horizontally polarized antenna (e.g., antenna 708 in FIG. 7) associated with a second radio receiving (RX) a second signal while operating in a low power mode (e.g., 2 dBm).

Performance diagram 922 shows range in feet versus throughput for the horizontally polarized antenna associated with the second radio receiving the second signal while operating in the low power mode. With respect to performance diagram 922, only the second radio is operational. Performance diagram 924 shows range in feet versus throughput for the vertically polarized antenna associated with the first radio transmitting the first signal while operating in the full power mode. With respect to performance diagram 924, only the first radio is operational.

Performance diagram 926 shows range in feet versus throughput for the horizontally polarized antenna associated with the second radio receiving the second signal while operating in the low power mode. With respect to performance diagram 926, both of the radios are operational. Performance diagram 928 shows range in feet versus throughput for the vertically polarized antenna associated with the first radio transmitting the first signal while operating in the full power mode. With respect to performance diagram 928, both of the radios are operational.

In FIG. 9C, the graphical representation 930 shows performance diagrams 932, 934, 936, and 938 with a vertically polarized antenna (e.g., antenna 704 in FIG. 7) associated with a first radio transmitting (TX) a first signal while operating in a full power mode (e.g., 23 dBm) and a horizontally polarized antenna (e.g., antenna 708 in FIG. 7) associated with a second radio transmitting (TX) a second signal while operating in a low power mode (e.g., 2 dBm).

Performance diagram 932 shows range in feet versus throughput for the horizontally polarized antenna associated with the second radio transmitting the second signal while operating in the low power mode. With respect to performance diagram 932, only the second radio is operational. Performance diagram 934 shows range in feet versus throughput for the vertically polarized antenna associated with the first radio transmitting the first signal while operating in the full power mode. With respect to performance diagram 934, only the first radio is operational.

Performance diagram 936 shows range in feet versus throughput for the horizontally polarized antenna associated with the second radio transmitting the second signal while operating in the low power mode. With respect to performance diagram 936, both of the radios are operational. Performance diagram 938 shows range in feet versus throughput for the vertically polarized antenna associated with the first radio transmitting the first signal while operating in the full power mode. With respect to performance diagram 938, both of the radios are operational.

In FIG. 9D, the graphical representation 940 shows performance diagrams 942, 944, 946, and 948 with a vertically polarized antenna (e.g., antenna 704 in FIG. 7) associated with a first radio receiving (RX) a first signal while operating in a full power mode (e.g., 23 dBm) and a horizontally polarized antenna (e.g., antenna 708 in FIG. 7) associated with a second radio receiving (RX) a second signal while operating in a low power mode (e.g., 2 dBm).

Performance diagram 942 shows range in feet versus throughput for the horizontally polarized antenna associated with the second radio receiving the second signal while operating in the low power mode. With respect to performance diagram 942, only the second radio is operational. Performance diagram 944 shows range in feet versus throughput for the vertically polarized antenna associated with the first radio receiving the first signal while operating in the full power mode. With respect to performance diagram 944, only the first radio is operational.

Performance diagram 946 shows range in feet versus throughput for the horizontally polarized antenna associated with the second radio receiving the second signal while operating in the low power mode. With respect to performance diagram 946, both of the radios are operational. Performance diagram 948 shows range in feet versus throughput for the vertically polarized antenna associated with the first radio receiving the first signal while operating in the full power mode. With respect to performance diagram 948, both of the radios are operational.

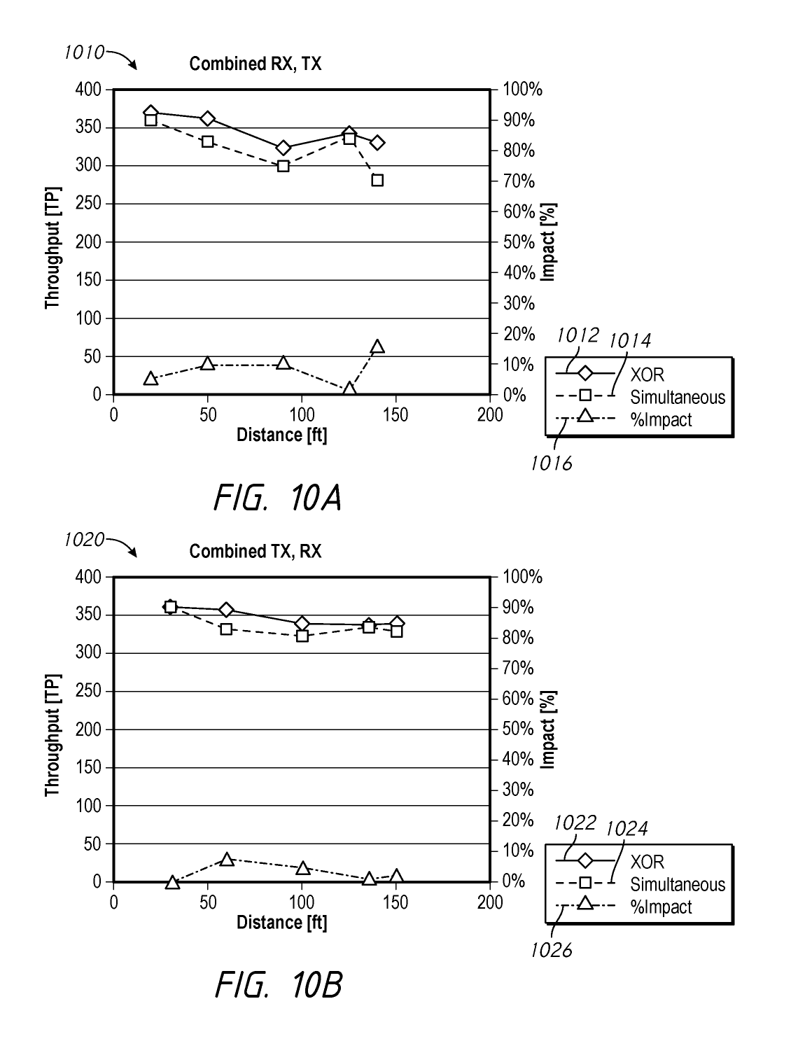

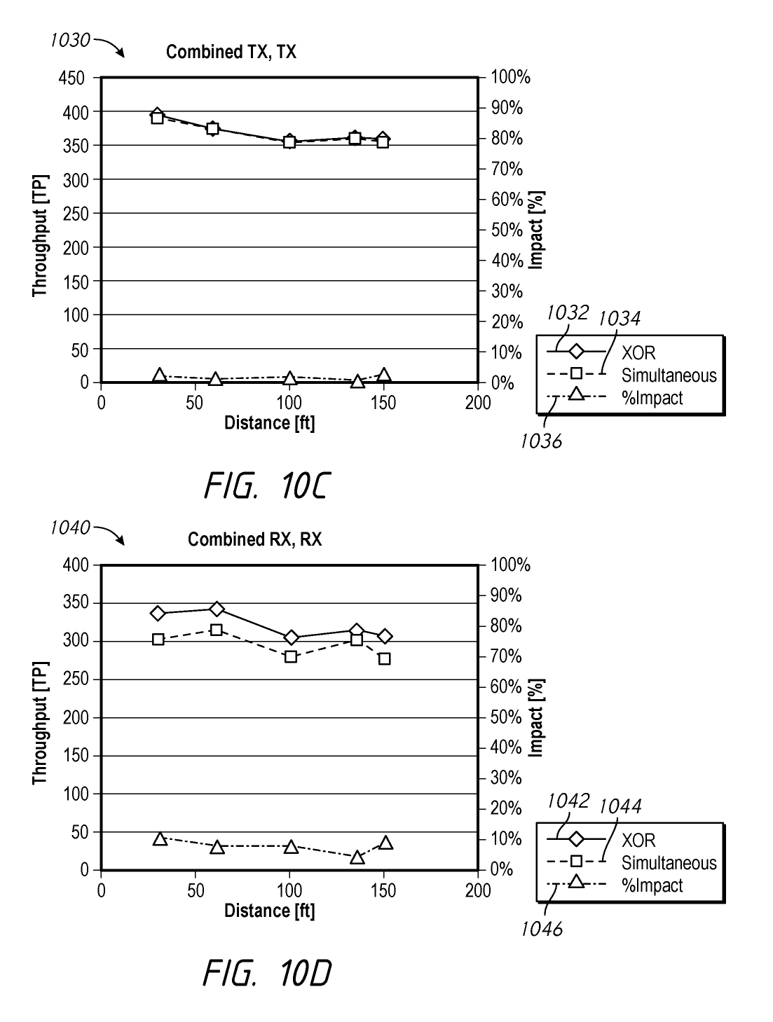

FIGS. 10A-10D show example performance diagrams of combined data associated with performance diagrams in FIGS. 9A-9D for various operating scenarios in accordance with some implementations. The performance diagrams in FIGS. 10A-10D are non-limiting examples. Those of ordinary skill in the art will appreciate from the present disclosure that the performance diagrams in FIGS. 10A-10D change according to the operating parameters and/or operating conditions in various other implementations. In FIG. 10A, the graphical representation 1010 shows performance diagrams 1012, 1014, and 1016. Performance diagram 1012 is combination of the throughputs for each link in performance diagrams 912 and 914 in FIG. 9A. In other words, according to various implementations, the performance diagram 1012 is equivalent to the total ideal throughput if the two links had no interfering impact on each other. Performance diagram 1014 is combination of the throughputs for each link in performance diagrams 916 and 918 in FIG. 9A. In other words, according to various implementations, the performance diagram 1014 shows the realistic throughout with simultaneous communication of both radios. Performance diagram 1016 shows the impact on throughput between performance diagrams 1012 and 1014 in FIG. 10A.

In FIG. 10B, the graphical representation 1020 shows performance diagrams 1022, 1024, and 1026. Performance diagram 1022 is combination of the throughputs for each link in performance diagrams 922 and 924 in FIG. 9B. Performance diagram 1024 is combination of the throughputs for each link in performance diagrams 926 and 928 in FIG. 9B. Performance diagram 1026 shows the impact on throughput between performance diagrams 1022 and 1024 in FIG. 10B.

In FIG. 10C, the graphical representation 1030 shows performance diagrams 1032, 1034, and 1036. Performance diagram 1032 is combination of the throughputs for each link in performance diagrams 932 and 934 in FIG. 9C. Performance diagram 1034 is combination of the throughputs for each link in performance diagrams 936 and 938 in FIG. 9C. Performance diagram 1036 shows the impact on throughput between performance diagrams 1032 and 1034 in FIG. 10C.

In FIG. 10D, the graphical representation 1040 shows performance diagrams 1042, 1044, and 1046. Performance diagram 1042 is combination of the throughputs for each link in performance diagrams 942 and 944 in FIG. 9D. Performance diagram 1044 is combination of the throughputs for each link in performance diagrams 946 and 948 in FIG. 9D. Performance diagram 1046 shows the impact on throughput between performance diagrams 1042 and 1044 in FIG. 10D.

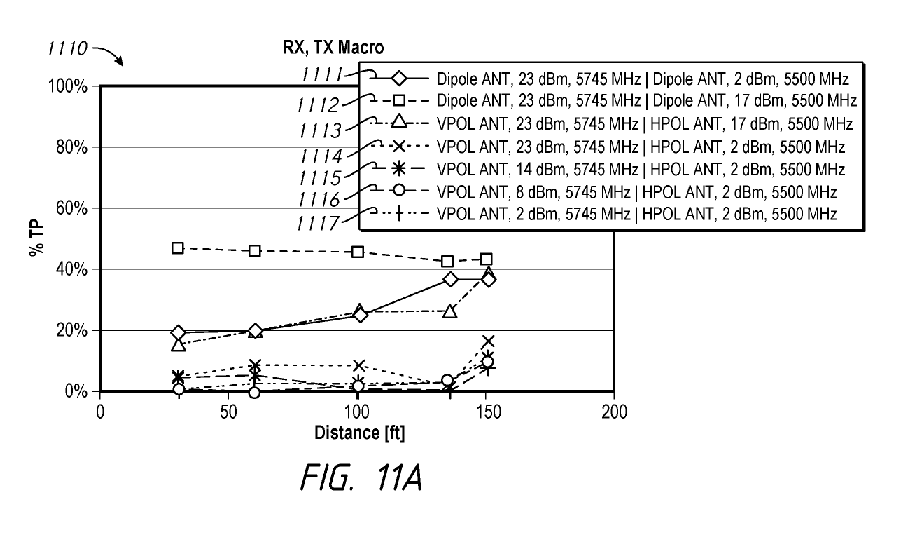

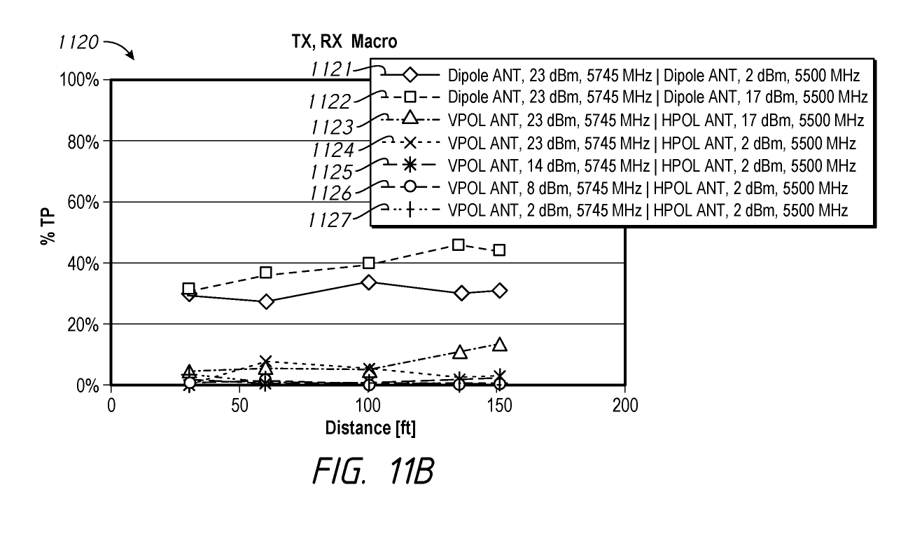

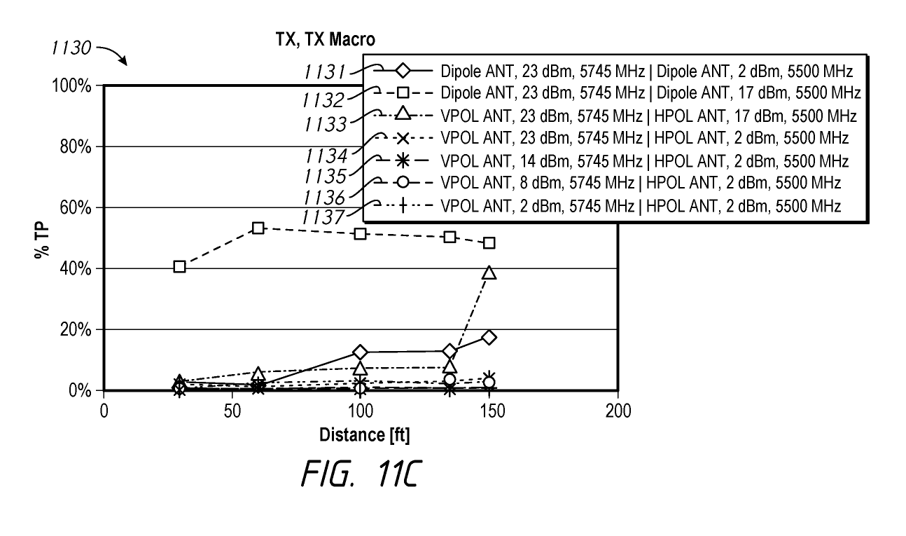

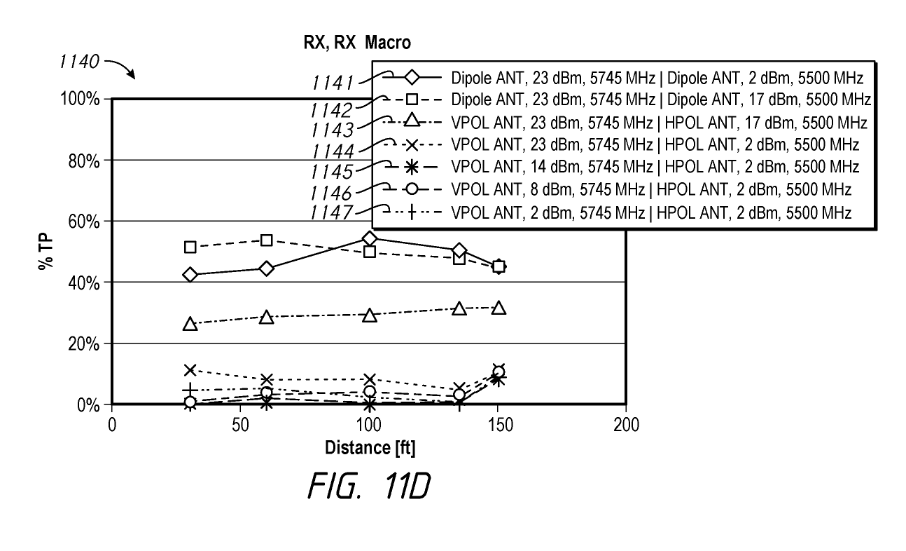

FIGS. 11A-11D show example performance diagrams of a first radio of the dual radio AP 702 in FIG. 7 operating in a macro mode for various operating scenarios in accordance with some implementations. The performance diagrams in FIGS. 11A-11D are non-limiting examples. Those of ordinary skill in the art will appreciate from the present disclosure that the performance diagrams in FIGS. 11A-11D change according to the operating parameters and/or operating conditions in various other implementations. In FIG. 11A, the graphical representation 1110 shows performance diagrams 1111, 1112, 1113, 1114, 1115, 1116, and 1117 indicating range in feet versus percentage impact on throughput for a first radio (e.g., associated with the antenna 704 in FIG. 7) of the dual radio AP 702, where the first radio (e.g., associated with the antenna 704 in FIG. 7) is operating in a reception mode (RX) and the second radio (e.g., associated with the antenna 708 in FIG. 7) is operating in a transmission mode (TX). The first radio operates in a full power mode (sometimes also herein called “macro mode” or “macro cell mode”) (e.g., 23 dBm) in at least some situations.

In performance diagram 1111, the first radio, associated with a dipole antenna, operates at 5745 MHz and 23 dBm power (e.g., full power mode) and the second radio, associated with a dipole antenna, operates at 5500 MHz and 2 dBm power (e.g., reduced power mode). In performance diagram 1112, the first radio, associated with a dipole antenna, operates at 5745 MHz and 23 dBm power, and the second radio, associated with a dipole antenna, operates at 5500 MHz and 17 dBm power.

In performance diagram 1113, the first radio, associated with a vertically polarized antenna, operates at 5745 MHz and 23 dBm power, and the second radio, associated with a horizontally polarized antenna, operates at 5500 MHz and 17 dBm power. In performance diagram 1114, the first radio, associated with a vertically polarized antenna, operates at 5745 MHz and 23 dBm power, and the second radio, associated with a horizontally polarized antenna, operates at 5500 MHz and 2 dBm power. In performance diagram 1115, the first radio, associated with a vertically polarized antenna, operates at 5745 MHz and 14 dBm power, and the second radio, associated with a horizontally polarized antenna, operates at 5500 MHz and 2 dBm power. In performance diagram 1116, the first radio, associated with a vertically polarized antenna, operates at 5745 MHz and 8 dBm power, and the second radio, associated with a horizontally polarized antenna, operates at 5500 MHz and 2 dBm power. In performance diagram 1117, the first radio, associated with a vertically polarized antenna, operates at 5745 MHz and 2 dBm power, and the second radio, associated with a horizontally polarized antenna, operates at 5500 MHz and 2 dBm power.

In FIG. 11B, the graphical representation 1120 shows performance diagrams 1121, 1122, 1123, 1124, 1125, 1126, and 1127 indicating range in feet versus percentage impact on throughput for a first radio (e.g., associated with the antenna 704 in FIG. 7) of the dual radio AP 702, where the first radio (e.g., associated with the antenna 704 in FIG. 7) is operating in a transmission mode (TX) and the second radio (e.g., associated with the antenna 708 in FIG. 7) is operating in a reception mode (RX). In performance diagrams 1121, 1122, 1123, 1124, 1125, 1126, and 1127, the first and second radios operate and are configured similarly to those in performance diagrams 1111, 1112, 1113, 1114, 1115, 1116, and 1117, respectively.

In FIG. 11C, the graphical representation 1130 shows performance diagrams 1131, 1132, 1133, 1134, 1135, 1136, and 1137 indicating range in feet versus percentage impact on throughput for a first radio (e.g., associated with the antenna 704 in FIG. 7) of the dual radio AP 702, where the first radio (e.g., associated with the antenna 704 in FIG. 7) is operating in a transmission mode (TX) and the second radio (e.g., associated with the antenna 708 in FIG. 7) is operating in a transmission mode (TX). In performance diagrams 1131, 1132, 1133, 1134, 1135, 1136, and 1137, the first and second radios operate and are configured similarly to those in performance diagrams 1111, 1112, 1113, 1114, 1115, 1116, and 1117, respectively.

In FIG. 11D, the graphical representation 1140 shows performance diagrams 1141, 1142, 1143, 1144, 1145, 1146, and 1147 indicating range in feet versus percentage impact on throughput for a first radio (e.g., associated with the antenna 704 in FIG. 7) of the dual radio AP 702, where the first radio (e.g., associated with the antenna 704 in FIG. 7) is operating in a reception mode (RX) and the second radio (e.g., associated with the antenna 708 in FIG. 7) is operating in a reception mode (RX). In performance diagrams 1141, 1142, 1143, 1144, 1145, 1146, and 1147, the first and second radios operate and are configured similarly to those in performance diagrams 1111, 1112, 1113, 1114, 1115, 1116, and 1117, respectively.

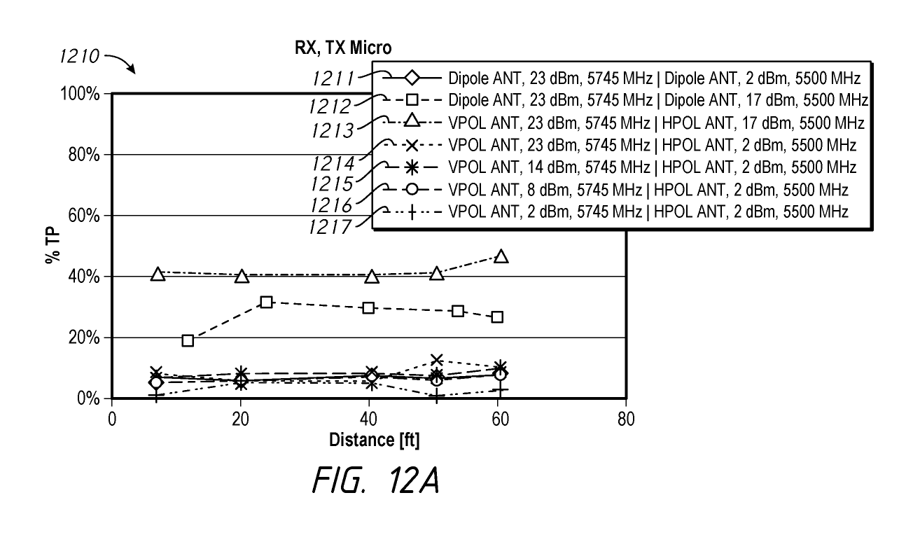

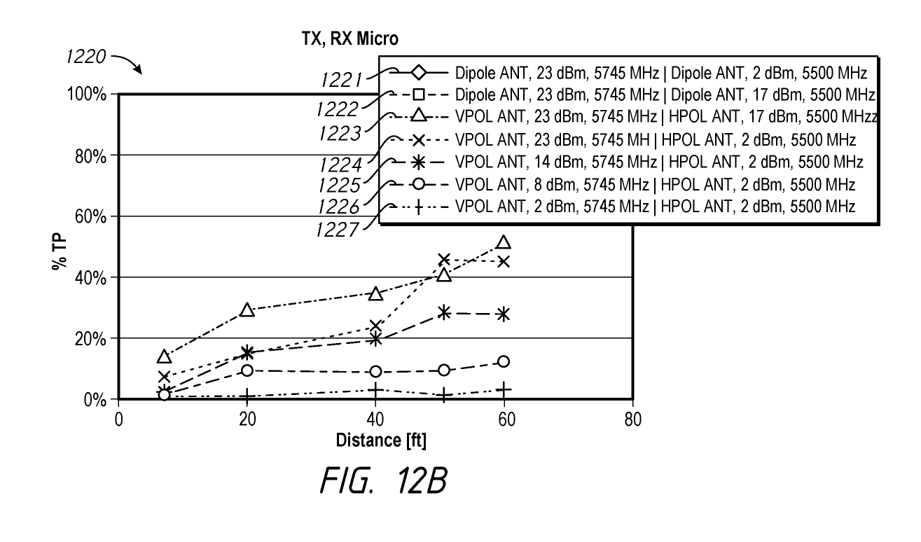

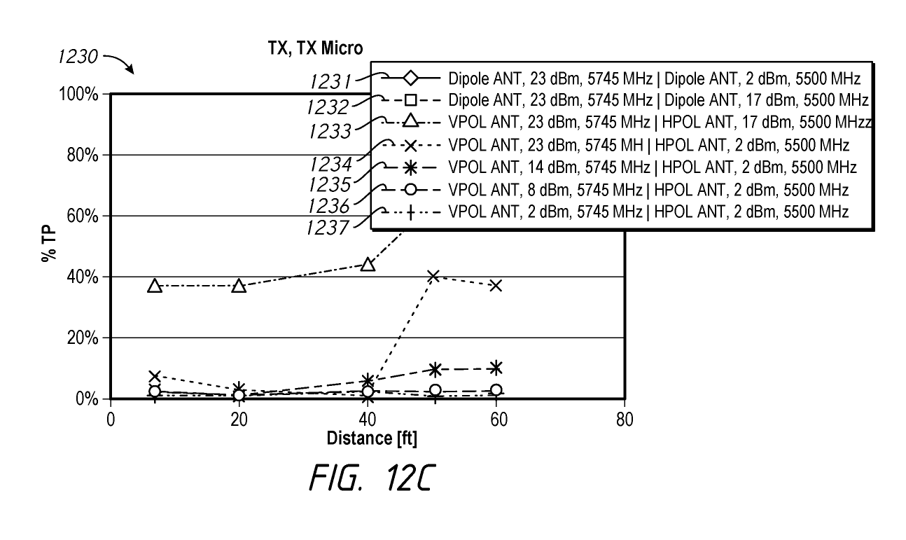

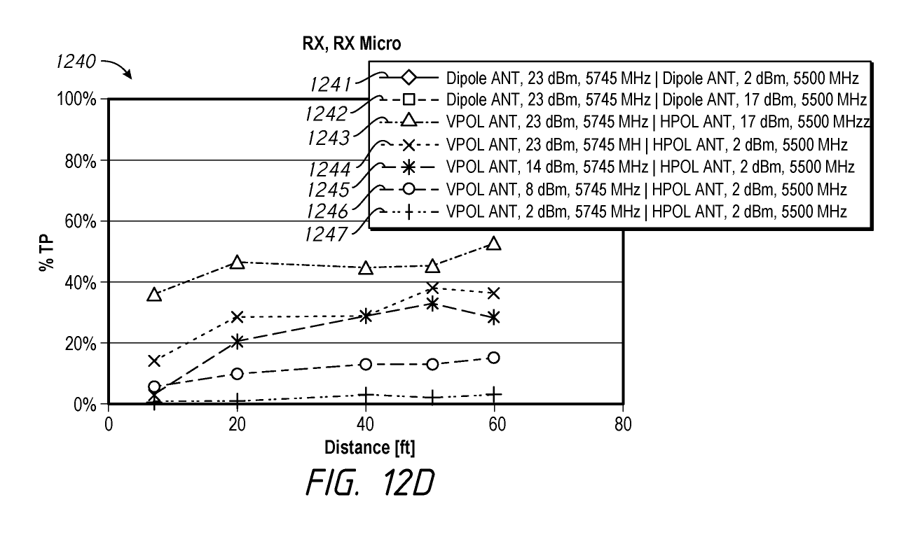

FIGS. 12A-12D show example performance diagrams of a second radio of the dual radio AP 702 in FIG. 7 operating in a micro mode for various operating scenarios in accordance with some implementations. The performance diagrams in FIGS. 12A-12D are non-limiting examples. Those of ordinary skill in the art will appreciate from the present disclosure that the performance diagrams in FIGS. 12A-12D change according to the operating parameters and/or operating conditions in various other implementations. In FIG. 12A, the graphical representation 1210 shows performance diagrams 1211, 1212, 1213, 1214, 1215, 1216, and 1217 indicating range in feet versus percentage impact on throughput for a second radio (e.g., associated with the antenna 708 in FIG. 7) of the dual radio AP 702, where the first radio (e.g., associated with the antenna 704 in FIG. 7) is operating in a reception mode (RX) and the second radio (e.g., associated with the antenna 708 in FIG. 7) is operating in a transmission mode (TX). The second radio operates in a reduced power mode (sometimes also herein called “micro mode” or “micro cell mode”) (e.g., 2 dBm) in at least some situations.

In performance diagram 1211, the first radio, associated with a dipole antenna, operates at 5745 MHz and 23 dBm power (e.g., full power mode), and the second radio, associated with a dipole antenna, operates at 5500 MHz and 2 dBm power (e.g., reduced power mode). In performance diagram 1212, the first radio, associated with a dipole antenna, operates at 5745 MHz and 23 dBm power, and the second radio, associated with a dipole antenna, operates at 5500 MHz and 17 dBm power.

In performance diagram 1213, the first radio, associated with a vertically polarized antenna, operates at 5745 MHz and 23 dBm power, and the second radio, associated with a horizontally polarized antenna, operates at 5500 MHz and 17 dBm power. In performance diagram 1214, the first radio, associated with a vertically polarized antenna, operates at 5745 MHz and 23 dBm power, and the second radio, associated with a horizontally polarized antenna, operates at 5500 MHz and 2 dBm power. In performance diagram 1215, the first radio, associated with a vertically polarized antenna, operates at 5745 MHz and 14 dBm power, and the second radio, associated with a horizontally polarized antenna, operates at 5500 MHz and 2 dBm power. In performance diagram 1216, the first radio, associated with a vertically polarized antenna, operates at 5745 MHz and 8 dBm power, and the second radio, associated with a horizontally polarized antenna, operates at 5500 MHz and 2 dBm power. In performance diagram 1217, the first radio, associated with a vertically polarized antenna, operates at 5745 MHz and 2 dBm power, and the second radio, associated with a horizontally polarized antenna, operates at 5500 MHz and 2 dBm power.

In FIG. 12B, the graphical representation 1120 shows performance diagrams 1221, 1222, 1223, 1224, 1225, 1226, and 1227 indicating range in feet versus percentage impact on throughput for a second radio (e.g., associated with the antenna 708 in FIG. 7) of the dual radio AP 702, where the first radio (e.g., associated with the antenna 704 in FIG. 7) is operating in a transmission mode (TX) and the second radio (e.g., associated with the antenna 708 in FIG. 7) is operating in a reception mode (RX). In performance diagrams 1221, 1222, 1223, 1224, 1225, 1226, and 1227, the first and second radios operate and are configured similarly to those in performance diagrams 1211, 1212, 1213, 1214, 1215, 1216, and 1217, respectively.

In FIG. 12C, the graphical representation 1230 shows performance diagrams 1231, 1232, 1233, 1234, 1235, 1236, and 1237 indicating range in feet versus percentage impact on throughput for a second radio (e.g., associated with the antenna 708 in FIG. 7) of the dual radio AP 702, where the first radio (e.g., associated with the antenna 704 in FIG. 7) is operating in a transmission mode (TX) and the second radio (e.g., associated with the antenna 708 in FIG. 7) is operating in a transmission mode (TX). In performance diagrams 1231, 1232, 1233, 1234, 1235, 1236, and 1237, the first and second radios operate and are configured similarly to those in performance diagrams 1211, 1212, 1213, 1214, 1215, 1216, and 1217, respectively.

In FIG. 12D, the graphical representation 1240 shows performance diagrams 1241, 1242, 1243, 1244, 1245, 1246, and 1247 indicating range in feet versus percentage impact on throughput for a second radio (e.g., associated with the antenna 708 in FIG. 7) of the dual radio AP 702, where the first radio (e.g., associated with the antenna 704 in FIG. 7) is operating in a reception mode (RX) and the second radio (e.g., associated with the antenna 708 in FIG. 7) is operating in a reception mode (RX). In performance diagrams 1241, 1242, 1243, 1244, 1245, 1246, and 1247, the first and second radios operate and are configured similarly to those in performance diagrams 1211, 1212, 1213, 1214, 1215, 1216, and 1217, respectively.

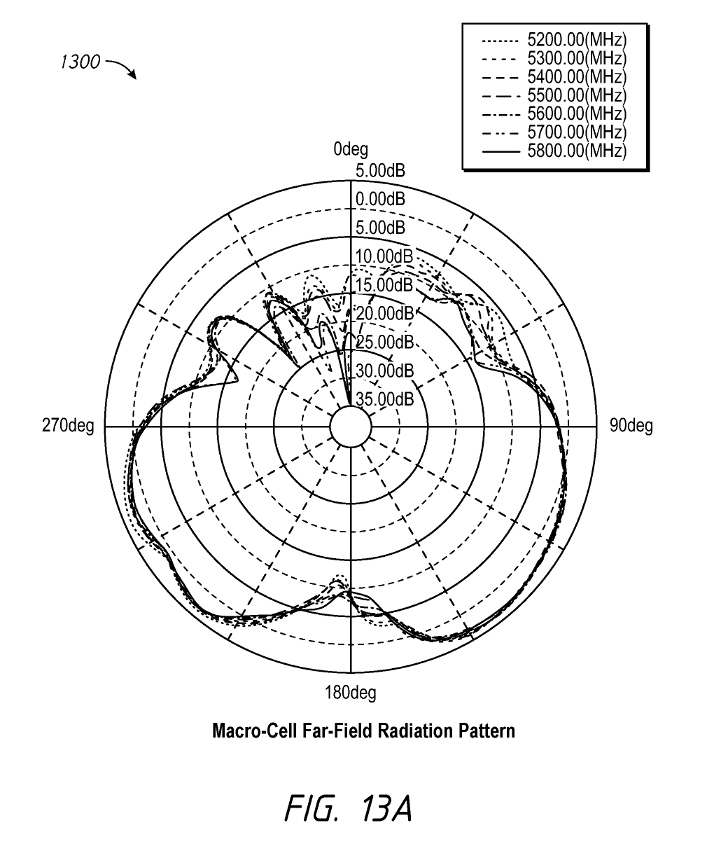

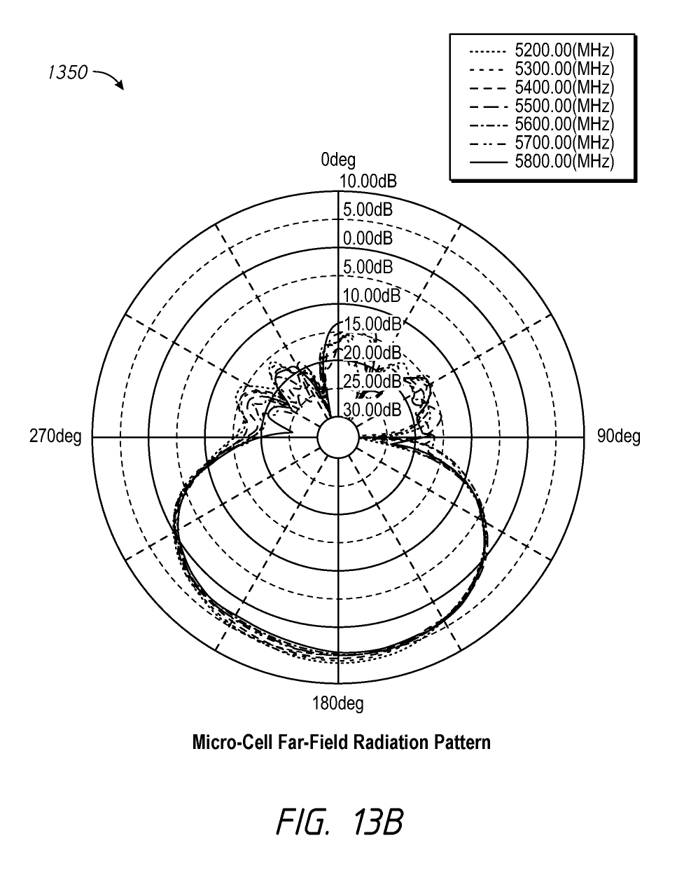

FIG. 13A illustrates an example far-field radiation pattern 1300 as taken from the antenna elevation plane of the first radio coupled to the antenna 704 of the dual radio AP 702 in FIG. 7 operating in a macro mode in accordance with some implementations. FIG. 13B illustrates an example far-field radiation pattern 1350 as taken from the antenna elevation plane of the second radio coupled to the antenna 708 of the dual radio AP 702 in FIG. 7 operating in a micro mode in accordance with some implementations.

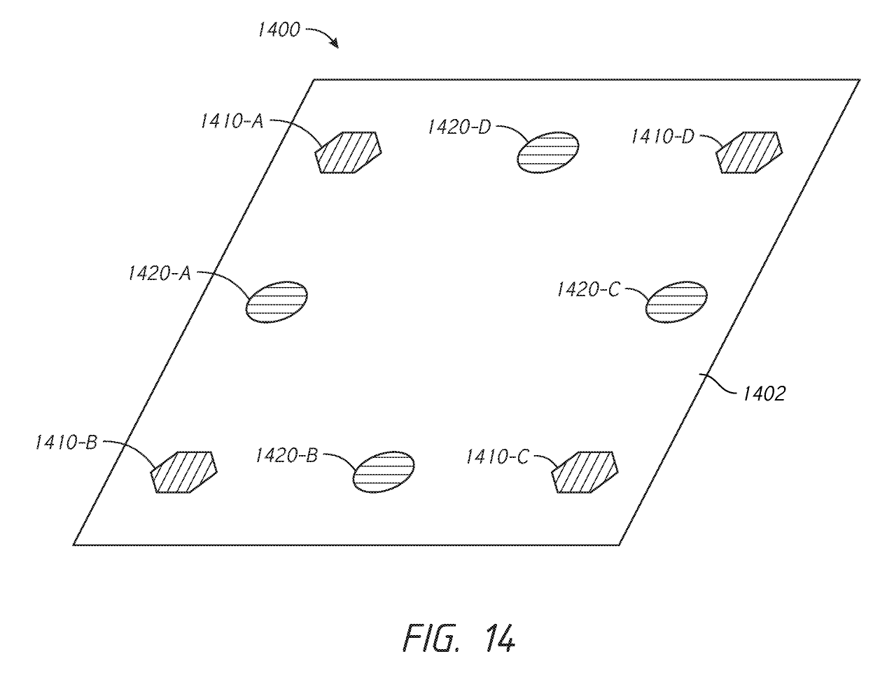

FIG. 14 is a schematic diagram of a device 1400 configured in accordance with some implementations. For example, in some implementations, the device 1400 is an access point (AP), router, switch, or the like. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1400 includes: a substrate 1402; a first set of antennas 1410-A, 1410-B, 1410-C, and 1410-D associated with a first radio; and a second set of antennas 1420-A, 1420-B, 1420-C, and 1420-D associated with a second radio.

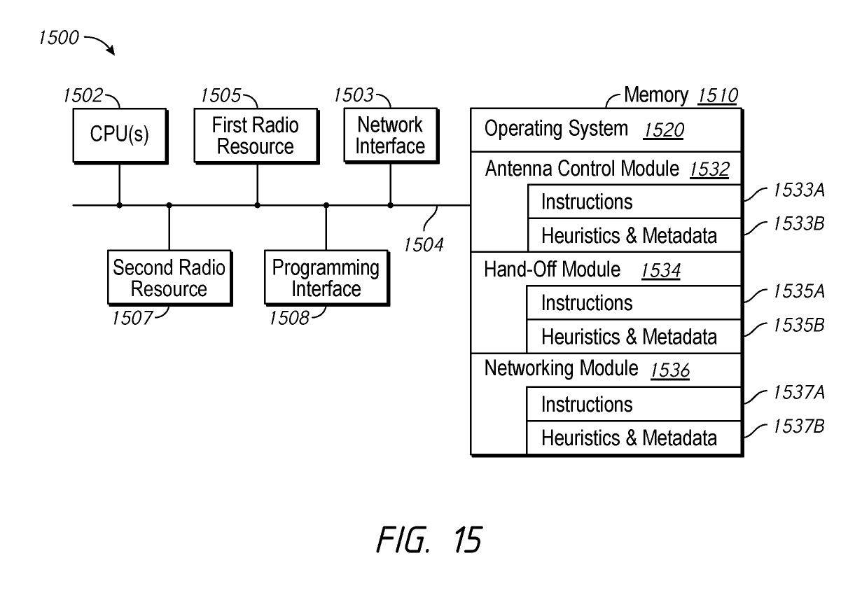

FIG. 15 is a block diagram of an example of a device 1500 configured in accordance with some implementations. For example, in some implementations, the device 1500 is an access point (AP), router, switch, or the like. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1500 includes one or more processing units (CPU's) 1502, a network interface 1503, a first radio resource 1505, a second radio resource 1507, a programming (I/O) interface 1508, a memory 1510, and one or more communication buses 1504 for interconnecting these and various other components.

In some implementations, the one or more communication buses 1504 include circuitry that interconnects and controls communications between system components. The memory 1510 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 1510 optionally includes one or more storage devices remotely located from the CPU(s) 1502. The memory 1510 comprises a non-transitory computer readable storage medium. In some implementations, the memory 1510 or the non-transitory computer readable storage medium of the memory 1510 stores the following programs, modules and data structures, or a subset thereof including an optional operating system 1520, an antenna control module 1532, a hand-off module 1534, and a networking module 1536. In some implementations, one or more instructions are included in a combination of logic and non-transitory memory.

In some implementations, the first radio resource 1505 is provided to support and facilitate traffic bearing communications between the device 1500 and one or more client devices. In some implementations, the first radio resource 1505 operates in combination with a first set of one or more antennas. In some implementations, the second radio resource 1507 is provided to support and facilitate traffic bearing communications between the device 1500 and one or more client devices. In some implementations, the second radio resource 1507 operates in combination with a second set of one or more antennas. For example, the first radio resource 1505 and the second radio resource 1507 operate in a same frequency band (e.g., the 5 GHz band according to IEEE 802.11n, IEEE 802.11ac, or the like).

The operating system 1520 includes procedures for handling various basic system services and for performing hardware dependent tasks.

In some implementations, the antenna control module 1532 is configured to control the first radio resource 1505 and the second radio resource 1507. To that end, in various implementations, the antenna control module 1532 includes instructions and/or logic 1533a, and heuristics and metadata 1533b.

In some implementations, the antenna control module 1532 includes a power control unit configured to operate the first radio resource 1505 according to a first power level and the second radio resource 1507 according to a second power level. In some implementations, the antenna control module 1532 includes a beamforming unit configured to operate the first radio resource 1505 according to a first directionality and the second radio resource 1507 according to a second directionality.

In some implementations, the hand-off module 1534 is configured to control hand-off access from the first radio resource 1505 to the second radio resource 1507 and vice versa. To that end, in various implementations, the hand-off module 1534 includes instructions and/or logic 1535a, and heuristics and metadata 1535b.

In some implementations, the networking module 1536 is configured to provide network access to one or more client devices (e.g., entertainment centers, laptops, desktop computers, tablets, smartphones, wearable computing devices, smart home controllers, smart illumination sources, manufacturing equipment, medical devices, or the like). To that end, in various implementations, the networking module 1536 includes instructions and/or logic 1537a, and heuristics and metadata 1537b.

Although the antenna control module 1532, the hand-off module 1534, and the networking module 1536 are illustrated as residing on a single device (i.e., the device 1500), it should be understood that in other implementations, any combination of the antenna control module 1532, the hand-off module 1534, and the networking module 1536 may reside in separate computing devices. For example, each of the antenna control module 1532, the hand-off module 1534, and the networking module 1536 may reside on a separate device.

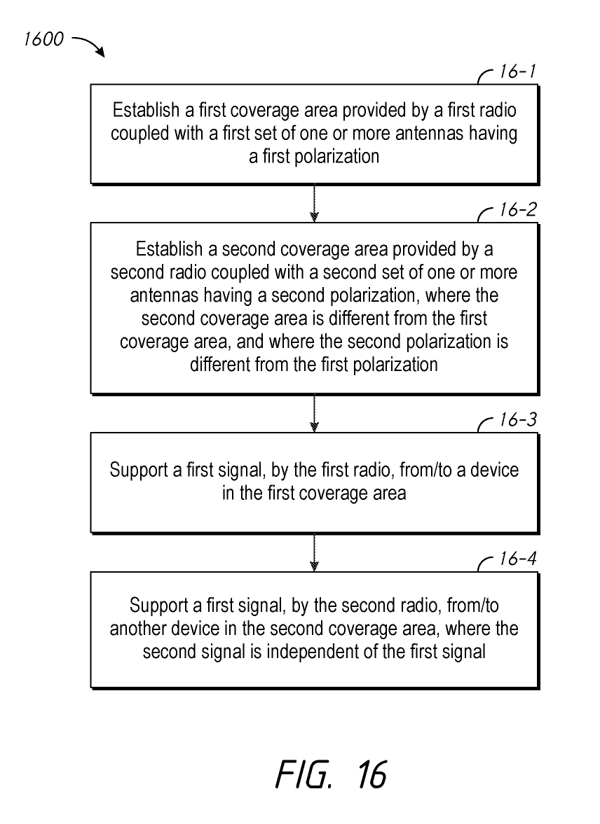

FIG. 16 is a flowchart representation of a method 1600 of operating a dual radio access point (AP) in accordance with some implementations. In various implementations, the method 1600 is performed by a dual radio AP (e.g., the dual radio AP 702 in FIG. 7). While pertinent features are shown, those of ordinary skill in the art will appreciate from the present disclosure that various other features have not been illustrated for the sake of brevity and so as not to obscure more pertinent aspects of the example implementations disclosed herein. To that end, briefly, in some circumstances, the method 1600 includes: establishing a first coverage area provided by a first radio coupled to a first set of one or more antennas having a first polarization; establishing a second coverage area provided by a second radio coupled to a second set of one or more antennas having a second polarization; supporting (e.g., receiving or transmitting) a first signal, by the first radio, from/to a device in the first coverage area; and supporting (e.g., receiving or transmitting) a second signal, by the second radio, from/to another device in the second coverage area

To that end, as represented by block 16-1, the method 1600 includes establishing a first coverage area provided by a first radio coupled to a first set of one or more antennas having a first polarization. For example, with reference to FIG. 7, a first radio of the dual radio AP 702, which is coupled to antenna 704, establishes a coverage area 720 with a radius X. For example, with reference to FIGS. 2 and 3, the first set of antennas are similar to and adapted from the first antenna 212 with vertical polarization 300 in FIG. 3.

As represented by block 16-2, the method 1600 includes establishing a second coverage area provided by a second radio coupled to a second set of one or more antennas having a second polarization, where the second coverage area is different from the first coverage area, and where the second polarization is different from the first polarization. For example, with reference to FIG. 7, a second radio of the dual radio AP 702, which is coupled to antenna 708, establishes a coverage area 710 with a radius 0.15 X. For example, with reference to FIGS. 2 and 4, the second set of antennas are similar to and adapted from the second antenna 214 with horizontal polarization 400 in FIG. 4.

In some implementations, the first set of one or more antennas associated with the first radio is characterized by a first polarization (e.g., strong vertical polarization) and the second set of one or more antennas associated with the second radio is characterized by a second polarization (e.g., strong horizontal polarization) to provide improved antenna isolation between radios operating in a same band. In some implementations, the second polarization is set relative to the first polarization to satisfy an isolation criterion (e.g., at least 30 dB, 40 dB, etc. of isolation). For example, the first polarization is orthogonal to the second polarization. In some implementations, the first polarization is not purely orthogonal to the second polarization. In fact, any polarization diversity provides improved antenna isolation between radios operating in a same band. In some implementations, the first and second polarizations satisfy an angular threshold relative to one another (e.g., at least a 75° offset). In some implementations, the angular threshold is indicative of an amount of polarization diversity that satisfies an isolation criterion.

In some implementations, the dual radio AP or a component thereof (e.g., the antenna control module 1532, FIG. 15) is configured to operate the first radio associated with the first set of one or more antennas in order to establish a first coverage area (e.g., a macro cell) and to operate the second radio associated with a second set of one or more antennas in order to establish the second coverage area (e.g., a micro cell). In some implementations, the first radio is operated according to a first power level in order to establish the first coverage area, and the second radio is operated according to a second power level in order to establish the second coverage area. For example, the first power level is greater than the second power level. In some implementations, the second power level is set relative to the first power level to satisfy an isolation criterion (e.g., at least 30 dB, 40 dB, etc. of isolation).

As represented by block 16-3, the method 1600 includes supporting a first signal, by the first radio, from or to a device in the first coverage area.

As represented by block 16-4, the method 1600 includes supporting a second signal, by the second radio, from or to another device in the second coverage area, where the second signal is independent of the first signal. In one example, the first radio transmits a first information bearing signal to the device in the first coverage area, and the second radio receives a second information bearing signal from another device in the second coverage area. In another example, the first radio receives a first information bearing signal from the device in the first coverage area, and the second radio transmits a second information bearing signal to another device in the second coverage area. In yet another example, the first radio transmits a first information bearing signal to the device in the first coverage area, and the second radio transmits a second information bearing signal to another device in the second coverage area.

In some implementations, the first radio includes a transmitter, and the second radio includes a receiver. In some implementations, the first radio includes a transmitter and a receiver, and the second radio includes a transmitter and a receiver. In some implementations, the first radio includes a transmitter and a receiver. In some implementations, the first radio includes a transmitter and a receiver, and the second radio includes a receiver.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structures and/or functionalities in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first antenna could be termed a second antenna, and, similarly, a second antenna could be termed a first antenna, which changing the meaning of the description, so long as all occurrences of the “first antenna” are renamed consistently and all occurrences of the “second antenna” are renamed consistently. The first antenna and the second antenna are both antennas, but they are not the same antenna.

The terminology used herein is for the purpose of describing particular embodiments only and is not intended to be limiting of the claims. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A device comprising:
a first set of one or more antennas having a first polarization;
a first radio coupled to the first set of one or more antennas, the combination of the first set of one or more antennas and the first radio supporting a first signal;
a second set of one or more antennas having a second polarization, wherein the second polarization is different from the first polarization; and
a second radio coupled to the second set of one or more antennas, the combination of the second set of one or more antennas and the second radio supporting a second signal, wherein the second signal is independent of the first signal.

2. The device of claim 1, wherein the second polarization is set relative to the first polarization to satisfy an isolation criterion.

3. The device of claim 1, wherein the first and second polarizations satisfy an angular threshold relative to one another.

4. The device of claim 3, wherein the angular threshold is indicative of an amount of polarization diversity that satisfies an isolation criterion.

5. The device of claim 1, wherein the first polarization is orthogonal to the second polarization.

6. The device of claim 1, wherein the first radio includes a transmitter and the second radio includes a receiver.

7. The device of claim 1, wherein the first radio includes a transmitter and the second radio includes a transmitter.

8. The device of claim 1, further comprising:
a third set of one or more antennas having a third polarization, wherein the third polarization is different from the first polarization and the second polarization; and
a third radio coupled to the third set of one or more antennas, the combination of the third set of one or more antennas and the third radio supporting a third signal, wherein the third signal is independent of the first signal and the second signal.

9. The device of claim 1, further comprising:
an antenna control module configured to operate the first radio in order to establish a first coverage area and to operate the second radio in order to establish a second coverage area different from the first coverage area.

10. The device of claim 9, wherein the first coverage area is greater than the second coverage area.

11. The device of claim 9, wherein the first radio is operated according to a first power level in order to establish the first coverage area, and
wherein the second radio is operated according to a second power level in order to establish the second coverage area different from the first coverage area.

12. The device of claim 11, wherein the second power level is set relative to the first power level to satisfy an isolation criterion.

13. The device of claim 11, wherein the first power level is greater than the second power level.

14. A device comprising:
a plurality of antennas each having a respective polarization, wherein the respective polarizations of each antenna are set in order to satisfy an isolation criterion relative to one or more adjacent antennas within the plurality of antennas;
a first radio coupled to a first antenna of the plurality of antennas, the combination of the first antenna and the first radio supporting a first signal; and
a second radio coupled to a second antenna of the plurality of antennas, the combination of the second antenna and the second radio supporting a second signal, wherein the second signal is independent of the first signal.

15. The device of claim 14, further comprising:
a third radio coupled to a third antenna of the plurality of antennas, the combination of the third antenna and the third radio supporting a third signal, wherein the third signal is independent of the first signal and the second signal.

16. The device of claim 14, further comprising:
an antenna control module, comprising one or more controllers and a non-transitory memory storing one or more programs, which when executed by the one or more controllers cause the device to:
operate the first radio in order to establish a first coverage area and to operate the second radio in order to establish a second coverage area different from the first coverage area.

17. The device of claim 16, wherein the first radio is operated according to a first power level in order to establish the first coverage area, and
wherein the second radio is operated according to a second power level in order to establish the second coverage area different from the first coverage area.

18. The device of claim 17, wherein the second power level is set relative to the first power level to satisfy an isolation criterion.

19. The device of claim 14, further comprising:
an antenna control module, comprising logic configured to operate the first radio in order to establish a first coverage area and to operate the second radio in order to establish a second coverage area.

20. A system comprising:
a plurality of antennas each having a respective polarization, wherein the respective polarizations of each antenna are set in order to satisfy an isolation criterion relative to one or more adjacent antennas within the plurality of antennas;
a first radio coupled to a first antenna of the plurality of antennas, the combination of the first antenna and the first radio supporting a first signal;
a second radio coupled to a second antenna of the plurality of antennas, the combination of the second antenna and the second radio supporting a second signal, wherein the second signal is independent of the first signal;
one or more processors; and
a non-transitory memory storing one or more programs, which when executed by the one or more controllers cause the device to operate the first radio in order to establish a first coverage area and to operate the second radio in order to establish a second coverage area.
